(19) United States
(12) Patent Application Publication
(10) Pub. No.: US 2015/0115189 A1
(43) Pub. Date: Apr. 30, 2015

(54) WASTE GATE ASSEMBLY FOR TURBOCHARGER

(71) Applicants: Hyundai Motor Company, Seoul (KR); Hyundai Wia Corporation, Changwon-si (KR)

(72) Inventors: Kyung-Jae JUNG, Suwon-si (KR); Seung Yeon LEE, Seoul (KR); Kwang Hwan Kim, Suwon-si (KR); Gil-Beom LEE, Seoul (KR); Jun Gwan PARK, Suwon-si (KR); Sung-Jin YANG, Suwon-si (KR); Ui Yeon PARK, Pyeongtaek-si (KR); Kyung-Wook JIN, Incheon (KR)

(73) Assignees: Hyundai Motor Company, Seoul (KR); Hyundai Wia Corporation, Changwon-si (KR)

(21) Appl. No.: 14/310,837

(22) Filed: Jun. 20, 2014

(30) Foreign Application Priority Data
Oct. 30, 2013 (KR) 10-2013-0129961

(51) Int. Cl. F01D 17/10; F02B 37/18

(52) U.S. Cl. CPC F01D 17/105; F02B 37/186; F05D 2220/40
USPC 251/279; 251/315.01

(57) ABSTRACT

Disclosed is a waste gate assembly for a turbocharger that is provided at a side of a turbine into which an exhaust gas is introduced, and bypasses some of the exhaust gas introduced into the turbine to an outside. The waste gate assembly may include a boss that has a hole for discharging the exhaust gas and is provided at a waste gate main body, a valve that is provided to spherically come in contact with a valve mounting surface of the boss and selectively opens or closes the hole of the boss, and an actuator that is connected to the valve, and provides a rotational force to the valve.

### CROSS-REFERENCE TO RELATED APPLICATION

The present application claims priority of Korean Patent Application Number 10-2013-0129961 filed on Oct. 30, 2013, the entire contents of which application are incorporated herein for all purposes by this reference.

### BACKGROUND OF INVENTION

1. Field of Invention

The present invention relates to a turbocharger system, and more particularly, to a waste gate assembly for controlling flow of an exhaust gas depending on a driving condition of an engine.

2. Description of Related Art

In general, a turbocharger is a device that supercharges air for combustion for increasing combustion efficiency of an engine, and is mostly applied to a diesel engine. In recent years, the turbocharger has been applied to a gasoline engine.

The turbocharger includes a turbine that is rotated by an exhaust gas, and a compressor that compresses intake air by being rotated by the turbine, and has a structure in which the turbine and the compressor are connected by a shaft.

Meanwhile, when an excess boost pressure is generated in an intake manifold, since abnormal combustion or abnormality in the engine is caused, the turbocharger includes a waste gate assembly for suppressing the excess boost pressure depending on a driving condition.

The waste gate assembly is provided at an exhaust gas intake pipe on an upstream side of the turbine, and functions to prevent the intake air from being excessively compressed by the exhaust gas by bypassing some of the exhaust gas introduced into the turbine through the intake pipe to the outside.

As illustrated in FIGS. 1(a) and 1(b), at a general waste gate assembly 1, a boss 5 having a hole 3 for discharging an exhaust gas is provided and a valve 7 as a waste gate valve for selectively opening or closing the hole 3 of the boss 5 by being swung by the actuator.

Here, the valve 7 is provided as a flat type valve that can be swung by the actuator, and opens and closes the hole 3 of the boss 5 by being rotated up and down from a top surface of the boss 5 in the drawing.

In addition, in the waste gate assembly 1, since the valve 7 is in a flat type, the top surface of the boss 5 corresponding to the valve 7 is also provided as a flat valve mounting surface.

Accordingly, the valve 7 is separated from the top surface of the boss 5 by being swung upward by the actuator to completely open the hole 3 of the boss 5, and the valve closely comes in contact with the top surface of the boss 5 by being swung downward by the actuator to completely close the hole 3 of the boss 5.

However, in the related art, since the flat valve 7 closely comes in contact with the top surface of the boss 5 or is separated from the top surface by being swung up and down by the actuator to open or close the hole 3 of the boss 5, rattle noise of the turbocharger may be caused by impact of the valve 7 with the top surface of the boss 5.

Moreover, in the related art, when the hole 3 of the boss 5 is closed by the valve 7, since impact is given to the flat valve mounting surface as the top surface of the boss 5 due to the valve 7, crack of the turbine housing may finally occur.

Further, in the related art, since the hole 3 is opened or closed by completely opening or closing the hole 3 of the boss 5 through the valve 7, an opening area of the hole 3 is not controlled. For this reason, it is difficult to actively control a discharge amount of the exhaust gas.

In addition, in the related art, when the hole 3 of the boss 5 is closed through the valve 7, since the valve 7 blocks the hole of the boss 5 while overcoming a pressure of the exhaust gas, a driving power of the actuator is increased, so that wear of components of the waste gate valve may be increased, and lifespan of the components may be reduced.

That is, in the related art, since the valve 7 is rotated in a direction in which the pressure of the exhaust gas is applied to close the hole 3 of the boss 5, the driving power of the actuator 7 may be increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a waste gate assembly for a turbocharger having advantages of reducing rattle noise of a turbocharger due to collision of a boss with a valve, preventing crack of a turbine housing due to the collision of the boss with the valve, and actively controlling a discharge amount of an exhaust gas.

Further, the present invention has been made in an effort to provide a waste gate assembly for a turbocharger having advantages of reducing wear of components of the waste gate valve and expanding lifespan of the components by closing a hole of the boss by a small driving power of an actuator.

Various aspects of the present invention provide a waste gate assembly for a turbocharger that is provided at a side of a turbine into which an exhaust gas is introduced and bypasses some of the exhaust gas introduced into the turbine to an outside. The waste gate assembly may include a boss that has a hole for discharging the exhaust gas and is provided at a waste gate main body, a valve that is provided to spherically come in contact with a valve mounting surface of the boss and selectively opens or closes the hole of the boss, and an actuator that is connected to the valve and provides a rotational force to the valve.

In the waste gate assembly for a turbocharger of the present invention, the valve may include a connection rod that is connected to the actuator, and a spherical portion that is integrally or monolithically formed at the connection rod, and spherically comes in contact with the valve mounting surface of the boss. The connection rod may be disposed in a direction substantially perpendicular to an internal center of the hole of the boss, and is rotated by the actuator.

In the waste gate assembly for a turbocharger of the present invention, a spherical groove that is connected to the hole and spherically comes in contact with the spherical portion may be formed on the valve mounting surface of the boss. The spherical portion may include a spherical surface having a substantially semicircular shape, and the spherical groove may have a substantially semicircular shape corresponding to the spherical portion. The spherical portion may have a spherical surface having a substantially elliptical shape, and the spherical groove may have a substantially elliptical shape corresponding to the spherical portion.

In the waste gate assembly for a turbocharger of the present invention, the hole of the boss may be a single hole, and may be connected to the spherical groove. The hole of the boss may have a cross section of a circular shape. The hole of the boss may have a cross section of a semicircular shape. The hole of the boss may include a plurality of holes that may be connected to the spherical groove.

According to various aspects of the present invention, since the valve capable of being slidably rotated through the spherical portion with respect to the spherical groove of the boss, it is possible to reduce rattle noise of the turbocharger by preventing collision impact of the valve with the valve mounting surface of the boss.

Moreover, according to various aspects of the present invention, since the collision impact of the valve with the valve mounting surface of the boss can be reduced, it is possible to prevent crack of the turbine housing from occurring.

Further, according to various aspects of the present invention, since a slidably rotating amount of the valve with respect to the spherical groove of the boss can be adjusted through the actuator, it is possible to actively adjust a discharge amount of the exhaust gas bypassed through the hole of the boss.

In addition, according to exemplary embodiments of the present invention, since the valve is slidably rotated in a direction in which a pressure of the exhaust gas is applied to open or close the hole of the boss, it is possible to reduce a driving power of the actuator, so that it is possible to reduce wear of the valve and expand lifespan of the valve.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

These drawings are presented to describe exemplary embodiments of the present invention, and, thus, the technical spirit of the present invention should not be interpreted as being limited to the accompanying drawings.

FIGS. 1(a) and 1(b) are diagrams of a general waste gate assembly for a turbocharger.

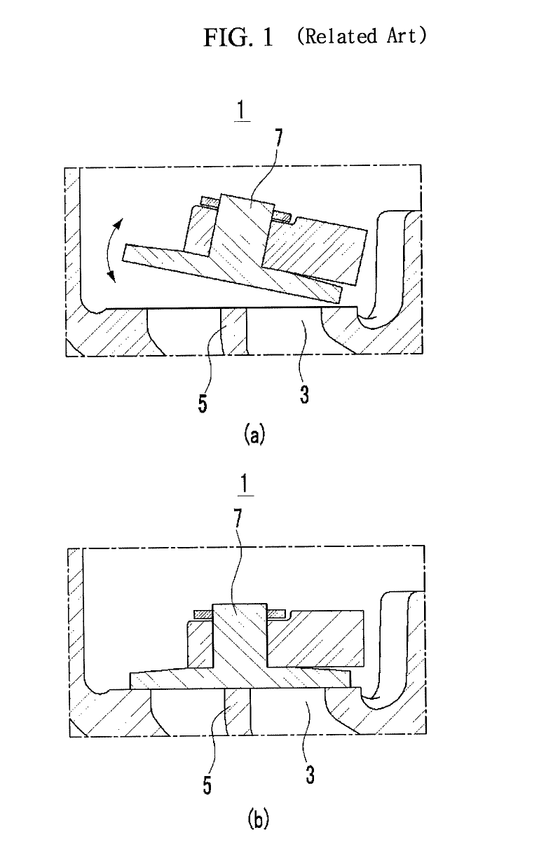

FIG. 2 is a schematic diagram of an exemplary waste gate assembly for a turbocharger according to the present invention.

FIGS. 3(a) and 3(b) are diagrams illustrating a boss applied to an exemplary waste gate assembly for a turbocharger according to the present invention.

FIGS. 4(a) and 4(b) are diagrams for describing on operation of a valve applied to an exemplary waste gate assembly for a turbocharger according to the present invention.

FIGS. 5(a) and 5(b) are schematic diagrams of an exemplary waste gate assembly for a turbocharger according to the present invention.

FIGS. 6(a) and 6(b) are schematic diagrams of an exemplary waste gate assembly for a turbocharger according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Unrelated parts will be omitted to clearly describe the present invention, and throughout the specification, the same or similar constituent elements will be assigned the same reference numeral. The size and thickness of each configuration shown in the drawings are arbitrarily shown for understanding and ease of description, but the present invention is not limited thereto. In the drawings, the various portions and regions are exaggerated for clarity.

Further, in the following detailed description, the terms ‘first,’ etc. given to components having the same configuration are only used to distinguish one component from another, and the terms do not necessarily denote any order in the following detailed description. Throughout the specification, unless explicitly described to the contrary, the word “comprise” and variations such as “comprises” or “comprising”, will be understood to imply the inclusion of stated elements but not the exclusion of any other elements.

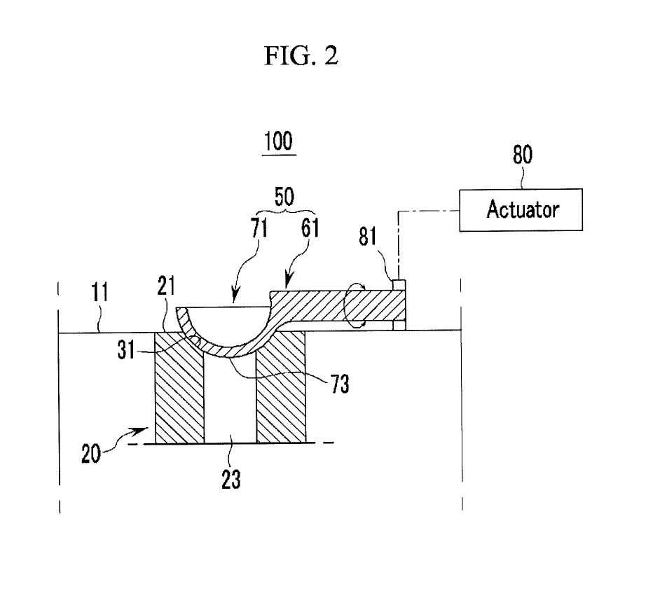

FIG. 2 is a schematic diagram of a waste gate assembly for a turbocharger according to an exemplary embodiment of the present invention. Referring to FIG. 2, a waste gate assembly 100 according to an exemplary embodiment of the present invention may be applied to a turbocharger system for a vehicle that supercharges air for combustion for increasing combustion efficiency of an engine.

For example, the turbocharger system includes a turbine that is rotated by an exhaust gas and a compressor that compresses intake air by being rotated by the turbine. In this case, the turbine and the compressor may be connected through a shaft. The turbocharger system may have a configuration of a turbocharger for a vehicle the same as or similar to those in the art, and, thus, a more detailed description thereof will not be presented in the present specification.

Meanwhile, in an engine that adopts the turbocharger system, when a boost pressure applied to an intake manifold is too large, abnormal combustion and abnormality in the engine may occur. Accordingly, the engine adopts the waste gate assembly 100 according to the exemplary embodiment of the present invention that can suppress an excess boost pressure depending on a driving condition of the engine.

The waste gate assembly 100 for a turbocharger according to the exemplary embodiment of the present invention is configured to bypass some of the exhaust gas introduced into the turbine to the outside, and may be provided at a side of a turbine housing to which the exhaust gas is introduced.

Here, the waste gate assembly 100 includes a waste gate main body 11 that is provided at the turbine housing. A bypass path for bypassing some of the exhaust gas introduced into the turbine is formed at the waste gate main body 11. Further, the waste gate assembly 100 for a turbocharger according to the exemplary embodiment of the present invention includes a waste gate valve for selectively opening or closing the bypass path of the waste gate main body 11.

The waste gate assembly 100 for a turbocharger according to the exemplary embodiment of the present invention has a structure in which rattle noise of the turbocharger can be reduced and crack of the turbine housing due to an operation of the waste gate valve can be prevented.

In addition, in the exemplary embodiment of the present invention, there is provided the waste gate assembly 100 for a turbocharger capable of actively control the discharge amount of the exhaust gas, reducing the wear of components constituting the waste gate valve, and extending the lifespan of the components.

To achieve this, the waste gate assembly 100 for a turbocharger according to the exemplary embodiment of the present invention basically includes a boss 20, a valve 50, and actuator 80. In the exemplary embodiment of the present invention, the boss 20 is provided at the bypass path of the waste gate main body 11 described above, and is a valve mounting boss for mounting the valve 50 to be described below.

In the drawing, a top surface of the boss 20 may be a valve mounting surface 21 for mounting the valve 50 in the exemplary embodiment of the present invention, and a hole 23 for bypassing some of the exhaust gas introduced into the turbine is formed in the boss 20. The hole 23 may be formed as a hole penetrating downward from the valve mounting surface 21 of the boss 20.

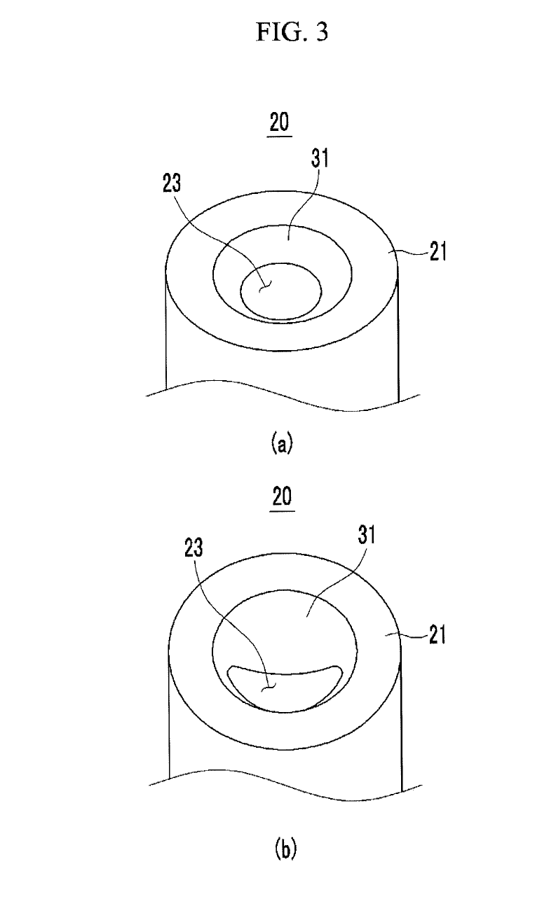

The hole 23 of the boss 20 may be a single hole, and may have a cross section of a circular shape as illustrated in FIG. 3(a), or a cross section of semicircular (half-moon) shape as illustrated in FIG. 3(b).

In the exemplary embodiment of the present invention, the valve 50 is a waste gate valve for selectively opening or closing the hole 23 of the boss 20 as illustrated in FIG. 2. The valve 50 is provided so as to spherically come in contact with the valve mounting surface 21 of the boss 20, and may be provided to be slidably rotated around a pivot shaft by the actuator 80 to be described. That is, the valve 50 may selectively open or close the hole 23 of the boss 20 while being slidably rotated on the valve mounting surface 21 of the boss 20.

The valve 50 includes a connection rod 61 that is connected to the actuator 80, and a spherical portion 71 having a hemispherical or substantially hemispherical shape that is integrally or monolithically formed at the connection rod 61 and spherically comes in contact with the valve mounting surface 21 of the boss 20.

Here, the connection rod 61 is disposed in a direction perpendicular or substantially perpendicular to an internal center of the hole 23 of the boss 20, and may be rotated by the actuator 80 back and forth in the drawing (an arrow direction in the drawing). The connection rod 61 may be provided as a pivot shaft of the actuator 80.

Further, the spherical portion 71 includes a semicircular spherical or substantially semicircular spherical surface 73, and the spherical surface 73 spherically comes in contact with the valve mounting surface 21 of the boss 20. For example, a lower surface of the spherical portion 71 may be formed as a convex spherical surface 73 having a circular spherical or substantially circular spherical shape, and a top surface thereof may be have a spoon bowl shape that is concave to have a hemispherical or substantially hemispherical shape.

Meanwhile, in the exemplary embodiment of the present invention, since the valve 50 includes the spherical portion 71 that spherically comes in contact with the valve mounting surface 21 of the boss 20, a spherical groove 31 that spherically comes in contact with the spherical surface 73 of the spherical portion 71 is formed on the valve mounting surface 21 of the boss 20 so as to correspond to the spherical surface 73 of the spherical portion 71.

For example, since the spherical surface 73 of the spherical portion 71 has a semicircular shape, the spherical groove 31 of the boss 20 is formed as a semicircular concave groove on the valve mounting surface 21 so as to be connected to the hole 23, and may slidably come in contact with the spherical surface 73 of the spherical portion 71 by the rotation of the valve 50. That is, the hole 23 of the boss 20 may be a single hole so as to connected to the spherical groove 31.

In the exemplary embodiment of the present invention, the actuator 80 is configured to provide a rotational force to the valve 50, and is provided so as to be connected to the valve 50. For example, the actuator 80 is driven by the boost pressure applied to the intake manifold, and moves in a straight-line motion. Further, the actuator may be connected to the connection rod 61 of the valve 50 through a hinge bar 81. That is, when the actuator 80 moves forward, the connection rod 61 of the valve 50 may be rotated in one direction, and when the actuator 80 moves backward, the connection rod 61 of the valve 50 may be rotated in the other direction.

The actuator 80 may have a configuration of an actuator the same as or similar to those in the art for driving the waste gate valve, and, thus, a more detailed description thereof may not presented in the present specification.

Accordingly, when the actuator 80 is driven, while the spherical portion 71 spherically comes in contact with the spherical groove 31 of the boss 20, the valve 50 can selectively open or close the hole 23 of the boss 20 by being slid or slidably rotated with respect to the spherical groove 31.

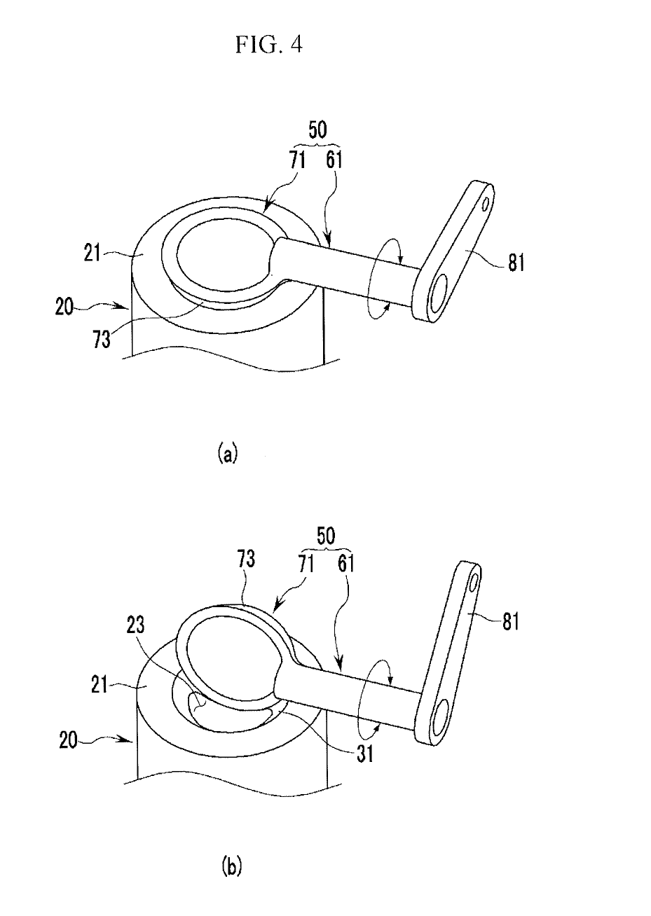

Hereinafter, the operation of the waste gate assembly 100 for a turbocharger according to the exemplary embodiment of the present invention having the aforementioned configuration will be described in detail with reference to the above-described drawings and FIGS. 4(a) and 4(b). FIGS. 4(a) and 4(b) are diagrams for describing an operation of the valve applied to the waste gate assembly for a turbocharger according to the exemplary embodiment of the present invention.

Firstly, referring to the above-described drawings and FIG. 4(a), in the exemplary embodiment of the present invention, when the boost pressure within the intake manifold is maintained at, for example, a predetermined range or less, the hole 23 of the boss 20 is maintained in a closed state by the spherical portion 71 of the valve 50.

In this case, while the spherical portion 71 spherically comes in contact with the spherical groove 31 of the boss 20, the valve 50 can close the hole 23 of the boss 20 by the spherical portion 71 by being slidably rotated in one direction by the driving of the actuator 80 with the connection rod 61 as a pivot shaft. Thus, since the exhaust gas introduced into the turbine is blocked by the spherical portion 71 of the valve 50, the exhaust gas is not bypassed through the hole 23 of the boss 20.

Meanwhile, in the exemplary embodiment of the present invention, when the boost pressure within the intake manifold exceeds the predetermined range, while the spherical portion 71 spherically comes in contact with the spherical groove 31 of the boss 20, the valve 50 is rotated in the other direction by the driving of the actuator 80 with the connection rod 61 as a pivot shaft, as illustrated in FIG. 4(b).

Accordingly, in exemplary embodiment of the present invention, the spherical portion 71 of the valve 50 is slidably rotated with respect to the spherical groove 31 of the boss 20 to open the hole 23 of the boss 20, and, thus, the exhaust gas can be bypassed through the hole 23.

Here, the discharge amount of the exhaust gas bypassed through the hole 23 of the boss 20 may be controlled by adjusting an opening degree of the hole 23, and the opening degree of the hole 23 may be adjusted by controlling a rotating amount of the valve 50 through the actuator 80.

Meanwhile, in the exemplary embodiment of the present invention, the hole 23 of the boss 20 can be opened or closed by slidably rotating the spherical portion 71 of the valve 50 while spherically coming in contact with the spherical groove 31 of the boss 20 in a direction in which a pressure of the exhaust gas is applied through the hole 23 of the boss 20.

According to the waste gate assembly 100 for a turbocharger according to the exemplary embodiment of the present invention described above, the spherical groove 31 may be formed on the valve mounting surface 21 of the boss 20, and the valve 50 that has the spherical portion 71 spherically coming in contact with the spherical groove 31 and is slidably rotated may be provided.

Accordingly, according to the exemplary embodiment of the present invention, it is possible to selectively open or close the hole 23 of the boss 20 by slidably rotating the valve 50 by the driving of the actuator 80 while the spherical portion 71 of the valve 50 spherically comes in contact with the spherical groove 31 of the boss 20.

Thus, according to the exemplary embodiment of the present invention, since there is provided the valve 50 that can be slidably rotated with respect to the spherical groove 31 of the boss 20 through the spherical portion 71, it is possible to reduce rattle noise of the turbocharger by preventing collision impact of the valve 50 with the valve mounting surface 21 of the boss 20.

Moreover, according to the exemplary embodiment of the present invention, since the collision impact of the valve 50 with the valve mounting surface 21 of the boss 20 can be reduced, it is possible to prevent crack of the turbine housing from occurring.

Further, according to the exemplary embodiment of the present invention, since a slidably rotating amount of the valve 50 with respectively the spherical groove 31 of the boss 20 through the actuator 80 can be adjusted, it is possible to actively adjust the discharge amount of the exhaust gas bypassed through the hole 23 of the boss 20.

In addition, according to the exemplary embodiment of the present invention, since the hole 23 of the boss 20 can be opened or closed while slidably rotating the valve 50 in the direction in which the pressure of the exhaust gas is applied, a driving power of the actuator 80 can be reduced, so that it is possible to reduce wear of the valve 50 and expand the lifespan of the valve.

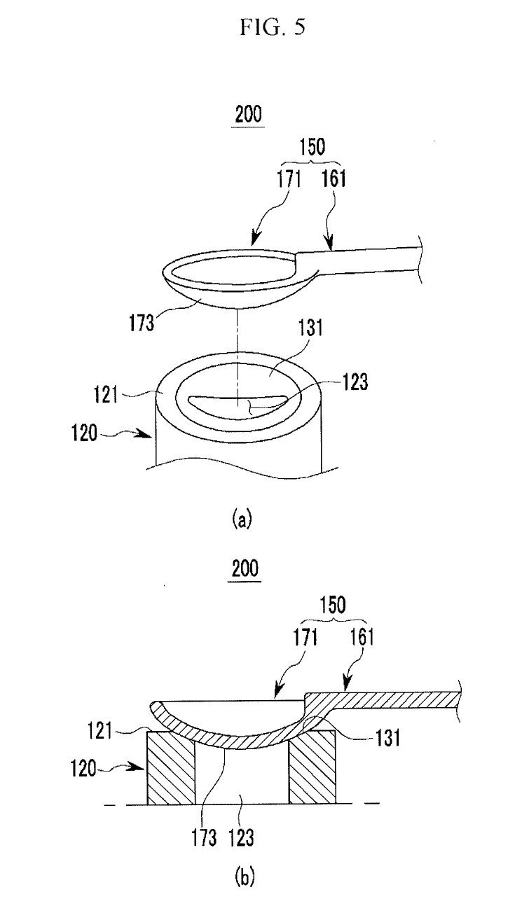

FIGS. 5(a) and 5(b) are schematic diagrams of a waste gate assembly for a turbocharger according to another exemplary embodiment of the present invention.

Referring to FIGS. 5(a) and 5(b), a waste gate assembly 200 for a turbocharger according to another exemplary embodiment of the present invention basically has the same or similar structure of the aforementioned exemplary embodiment, and may include a valve 150 in which a spherical portion 171 integrally or monolithically connected to the connection rod 161 has a spherical surface 173 having an elliptical shape.

A spherical groove 131 having an elliptical shape that spherically comes in contact with the spherical portion 171 of the valve 150 is formed on a valve mounting surface 121 of a boss 120 so as to correspond to the spherical portion 171. That is, it is possible to selectively open or close the hole 123 of the boss 120 by slidably rotating the valve 150 with respect to the spherical groove 131 having the elliptical shape while the spherical portion 171 having the elliptical shape spherically comes in contact with the spherical groove 131 of the boss 120.

Other configurations and operational effects of the waste gate assembly 200 for a turbocharger according to the another exemplary embodiment of the present invention are the same as those in the aforementioned exemplary embodiment, and, thus, more detailed descriptions thereof will not be presented.

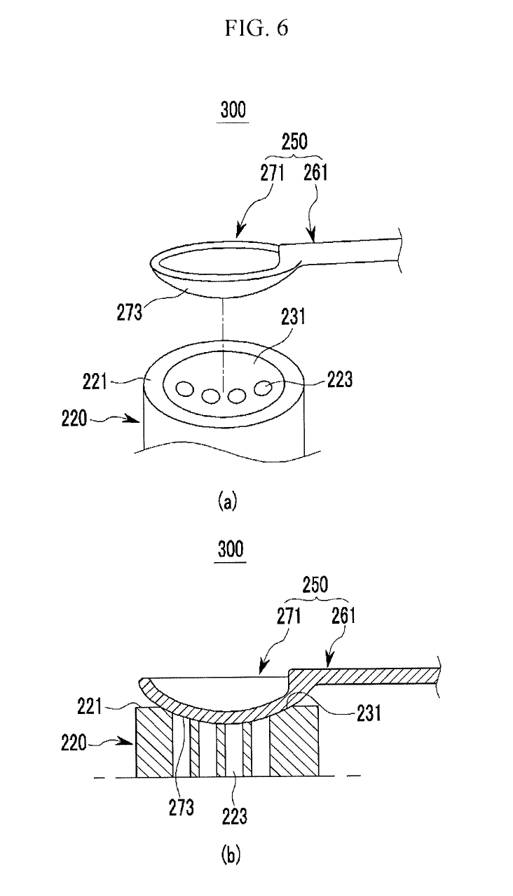

FIGS. 6(a) and 6(b) are schematic diagrams of a waste gate assembly for a turbocharger according to still another exemplary embodiment of the present invention. Referring to FIGS. 6(a) and 6(b), a waste gate assembly 300 for a turbocharger according to still another exemplary embodiment of the present invention basically has the structure of the aforementioned exemplary embodiment, and may a boss 220 in which a plurality of holes 223 is formed in a valve mounting surface 221.

Here, a valve 250 may include a connection rod 261, and a spherical portion 271 that is integrally or monolithically connected to the connection rod 261 and has a spherical surface 273 having an elliptical shape. Further, a spherical groove 231 having an elliptical shape that spherically comes in contact with the spherical portion 271 is formed on a valve mounting surface 221 of the boss 220.

In this case, the plurality of holes 223 is connected to the spherical groove 231 of the boss 220. The reason why the plurality of holes 223 is formed in the boss 220 is because interference of the exhaust gas with the spherical portion 271 is minimized when the holes 223 are opened by the slidably rotating of the valve 250.

Other configurations and operational effects of the waste gate assembly 300 for a turbocharger according to the still another exemplary embodiment of the present invention are the same as those in the aforementioned exemplary embodiments, and, thus, more detailed descriptions thereof will not be presented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For convenience in explanation and accurate definition in the appended claims, the terms “upper” or “lower”, “top” or “bottom”, “foreward” or“backward”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A waste gate assembly for a turbocharger that is provided at a side of a turbine into which an exhaust gas is introduced, and bypasses some of the exhaust gas introduced into the turbine to an outside, the waste gate assembly comprising:
a boss that has a hole for discharging the exhaust gas, and is provided at a waste gate main body;
a valve that is provided to spherically come in contact with a valve mounting surface of the boss and selectively opens or closes the hole of the boss; and
an actuator that is connected to the valve, and provides a rotational force to the valve.

2. The waste gate assembly for a turbocharger of claim 1, wherein the valve includes:
a connection rod that is connected to the actuator; and
a spherical portion that is integrally or monolithically formed at the connection rod, and spherically comes in contact with the valve mounting surface of the boss.

3. The waste gate assembly for a turbocharger of claim 2, wherein:
the connection rod is disposed in a direction substantially perpendicular to an internal center of the hole of the boss, and is rotated by the actuator.

4. The waste gate assembly for a turbocharger of claim 2, wherein:
a spherical groove that is connected to the hole and spherically comes in contact with the spherical portion is formed on the valve mounting surface of the boss.

5. The waste gate assembly for a turbocharger of claim 4, wherein:
the spherical portion includes a spherical surface having a substantially semicircular shape, and the spherical groove has a substantially semicircular shape corresponding to the spherical portion.

6. The waste gate assembly for a turbocharger of claim 4, wherein:
the spherical portion has a spherical surface having a substantially elliptical shape, and the spherical groove has a substantially elliptical shape corresponding to the spherical portion.

7. The waste gate assembly for a turbocharger of claim 4, wherein:
the hole of the boss is a single hole, and is connected to the spherical groove.

8. The waste gate assembly for a turbocharger of claim 7, wherein:
the hole of the boss has a cross section of a substantially circular shape.

9. The waste gate assembly for a turbocharger of claim 7, wherein:
the hole of the boss has a cross section of a substantially semicircular shape.

10. The waste gate assembly for a turbocharger of claim 4, wherein:
the hole of the boss includes a plurality of holes which are connected to the spherical groove.
